(19) United States
(12) Patent Application Publication
(10) Pub. No.: US 2007/0104190 A1
(43) Pub. Date: May 10, 2007

(54) User datagram protocol packet processing on network elements

(75) Inventors: Ole Harmjanz, New Delhi (IN); Martin Feith, Saarbrucken (DE)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/430,484

(22) Filed: May 8, 2006

(30) Foreign Application Priority Data
Nov. 7, 2005 (EP) 05024185.0

(51) Int. Cl. H04L 12/56; H04J 3/22

(52) U.S. Cl. 370/389; 370/465

(57) ABSTRACT

A device for user datagram protocol packet processing on network elements in a network, a radio access network comprising such a device and a method for user datagram protocol packet processing on network elements in a network, wherein a predetermined limited range of user datagram protocol port numbers is provided. It is determined, when a user datagram protocol packet arrives, whether a user datagram protocol port number associated with the user datagram protocol packet falls within the limited range of a user datagram protocol port numbers, and a mapping table is searched, if the associated user datagram protocol port number falls within the limited range of user datagram protocol port numbers, or the user datagram protocol packet is discarded or forwarded to an internet protocol means for further processing, if the associated user datagram protocol port number does not fall within the limited range of user datagram protocol numbers.

### CROSS-REFERENCE TO RELATED APPLICATION:

This application claims priority under 35 USC §119 to European Patent Application No. 05024185.0 filed on Nov. 7, 2005.

### FIELD OF THE INVENTION

The present invention relates to a device and a method for user datagram protocol packet processing on network elements in a network as well as to a radio access network means comprising such a device.

### BACKGROUND OF THE INVENTION

For example, the 3^{rd} Generation Partnership Program (3GPP) proposes two UTRAN (Universal Terrestrial Radio Access Network) transport options, i.e. ATM (Asynchronous Transfer Mode) UTRAN and IP (Internet Protocol) UTRAN (cf. e.g. 3GPP TR 25.933 v5.40). In an IP UTRAN, so called IP connections carry user plane traffic. If there is an IP connection control signalling (IPCCS) (cf. ITU-T Rec Q.2631.1), a dynamical set up and release of IP connections take place, in particular between IP UTRAN radio network controllers, between an IP UTRAN radio network controller (RNC) and an AAL2 (ATM Adaptation Layer 2)/IPCC Interworking Function (AAL2/IP IWF) device, between IP UTRAN 3G base stations (node B), between an IP UTRAN RNC and an IP UTRAN 3G base station (node B), and between an AAL2/IPCC IWF and an IP UTRAN 3G base station (node B). In order to establish such IP connections, the IPCCS (Internet Protocol Connection Control Signalling) protocol exchanges an IPTA (Internet Protocol Transport Sink Address) including IP addresses and an UDP (User Datagram Protocol) port number, and additional information such as SAID (Signalling Association Identifier), end addresses and traffic characteristics via signalling messages. An IPCC node implementation according to standard assumes the use of unique IPTA values in the IPCCS protocol at both peers for an IP connection corresponding with unique user plane UDP socket identifiers at both peers (called in the following unique UDP sockets).

To allow the release of reserved resources in case of suspected inconsistent information on two peer nodes a reset functionality allows to reset single IP connections or all IP connections associated with a particular IP address by sending the local source transport sink address, e.g. IPTA in case of the above described IP connections, to the peer node.

Upon receiving individual user plane packets the receiving node typically checks the IP connection identifiers including the destination IP addresses, the destination UDP port number, the source IP address and the source UDP port number, and decides how to process it. In particular, the receiving node decides whether the packet is for itself or whether it has to forward the packet to another node or to discard the packet due to an invalid IP connection.

Conventionally, when IP connections have been set up between two nodes, the receiving node has to compare every incoming UDP packet's destination port and IP address with entries in an IP/UDP connection look-up table, even if this packet does not carry any user plane traffic. If they are many IP connections, this can result in a rather big look-up table which has to be stored and to be processed. This may result in a poor performance of the system.

### SUMMARY OF THE INVENTION

An object of the present invention is to improve the performance of a system and a method for user datagram protocol packet processing on network elements in a network.

In order to achieve the above and further objects, according to a first aspect of the present invention, there is provided a device for user datagram protocol packet processing on network elements in a network, comprising user datagram protocol ports, wherein a predetermined limited range of user datagram protocol port numbers is provided only, mapping table means including a mapping table, means for determining, when a user datagram protocol packet arrives, whether or not a user datagram protocol port number associated with said user datagram protocol packet falls within said limited range of user datagram protocol port numbers, and means for searching through said mapping table, if said associated user datagram protocol port number is determined as falling within said limited range of user datagram protocol port numbers.

According to a second aspect of the present invention, there is provided a method for user datagram protocol packet processing on network elements in a network, comprising the steps of providing a predetermined limited range of user datagram protocol port numbers, determining, when a user datagram protocol packet arrives, whether or not a user datagram protocol port number associated with said user datagram protocol packet falls within said limited range of user datagram protocol port numbers, and searching through a mapping table, if said associated user datagram protocol port number is determined as falling within said limited range of user datagram protocol port numbers.

The present invention proposes to reserve a limited range of UDP port numbers for related traffic. Upon arrival of a packet, e.g. via Ethernet, it is checked whether or not a UDP port number associated with said packet falls within the above limited range of UDP port numbers. If yes, a mapping table is searched. All other IP traffic is classified as not related traffic and is discarded or forwarded to another IP device, which e.g. can be an external IP device and/or an IP stack, for further processing. In particular, not related traffic can be classified by three simple comparisons of the destination UDP socket with the IP address and the maximum and minimum allowed UDP port numbers.

The peer need not know about the limited range of UDP port numbers. Thus, the functionality of the node using the present invention is compatible with nodes which do not use the present invention. Also, the present invention can be used on at least two peers without one peer knowing the use of the present invention in the other peer. If a peer cannot restrict its range of UDP port numbers but can be informed during configuration of a minimum and maximum UDP port number of the other peer, it could also profit when classifying not related traffic by checking whether the received source UDP port numbers fall within the limited range of UDP port numbers.

The use of a limited range of UDP port numbers avoids the need for searching the rather large mapping tables used for UDP packets which are not provided for related traffic. So, due to the present invention a search through possible large mapping tables for related traffic is avoided. Moreover, cheaper hardware can be used or higher performance and/or more IP connections per node can be supported.

The related traffic carried by UDP/IP connections can be of any type of traffic depending on the kind of the network used. So, in the case of a GSM/EDGE radio access network where the mapping entries are set by management commands, the related traffic can comprise user plane traffic, signalling traffic or management traffic. In the case of a UTRAN, the related traffic consists of user plane traffic.

After all, the present invention results in an improvement of the performance of UDP packet processing on network elements in a network.

It is to be noted here that the present invention is not limited to a certain kind of IP connection or network. Further, the present application can preferably be implemented in 3GPP network elements, but is not limited thereto.

Moreover, the device according to the present invention can preferably be implemented in radio access network means like e.g. radio network controllers or base stations, e.g. 3G base stations (node B).

Further advantageous embodiments are defined in the dependent claims.

Said associated user datagram protocol port number can be a destination user datagram protocol port number or a source user datagram protocol port number.

If an associated user datagram protocol port number is determined as not falling within said limited range of user datagram protocol port numbers, the user datagram protocol packet is preferably discarded or forwarded to an internet protocol means for further processing.

According to a preferred embodiment of the present invention, when at least two peers are coupled to each other, at least one of the peers comprises a limited range of user datagram protocol port numbers, and at least another of the peers comprises a unique user datagram protocol port for each internet protocol connection. So, this embodiment allows the use of a small number of used user datagram protocol ports at the one peer and to require unique user datagram protocol ports for each individual internet protocol connection at the other peer. Alternatively or additionally, at least two of the peers comprise a limited range of user datagram protocol port numbers. Again, the usage of a small amount of user datagram protocol sockets reduces the mapping or look-up table processing for related traffic, and additionally the classification of not related traffic can be implemented efficiently.

Preferably, the limited range of user datagram protocol port numbers can be reduced even to one common user datagram protocol port. The usage of only one user datagram protocol socket further reduces the mapping table processing for user plane traffic, and additionally the classification of not related traffic can be implemented more efficiently. In particular, not related traffic can be classified by a simple comparison of the destination UDP socket in a single or considerable small numbers of operations instead of the usage of a table search algorithm. If either the destination UDP socket or the source UDP socket is unique, the mapping table processing can be considerably reduced. Finally, the number of usable UDP sockets for other applications on the node with a common UDP socket can be reduced by only the common UDP socket.

According to a further preferred embodiment of the present invention, user datagram protocol ports are provided for connection control signalling and related traffic so that the user datagram protocol packet processing on network elements is configured via connection control signalling, e.g. IP connection control signalling.

In this embodiment, the actually used user datagram protocol port numbers for the internet protocol connections can be separated from internet protocol transport sink address values transferred in the protocol of the internet protocol connection control signalling. Moreover, the internet protocol transport sink address values at least at two of the peers are uniquely associated with each individual internet protocol connection and, thus, enable all required internet protocol connection control signalling procedures. According to a still further modification of this embodiment, the internet protocol transport sink address values can be mapped to said limited range of user datagram protocol port numbers at least at one of the peers, while at least at another of the peers there is a one-to-one mapping between the internet protocol transport sink address values and the user datagram protocol ports.

Preferably, the connection control signalling is an internet protocol connection control signalling. However, any other kind of connection control signalling can be used with the present invention.

Alternatively or additionally to the use of internet protocol connection control signalling, predetermined user datagram protocol ports can be provided for related traffic.

According to a further preferred embodiment of the present invention, it is determined, when a user datagram protocol packet arrives, whether or not a destination internet protocol address associated with said user datagram protocol packet is the internet protocol address of a receiving device, and said user datagram protocol packet is forwarded to said means for determining whether or not a user datagram protocol port number associated with said user datagram protocol packet falls within said limited range of user datagram protocol port numbers, if said destination internet protocol address is determined as being the internet protocol address of the receiving device, or discarded or forwarded to a different destination means, if said destination internet protocol address is determined as being not the internet protocol address of the receiving device. So, when a packet arrives, then the receiving node first checks whether or not the destination internet protocol address is for itself. If not, the packet is discarded or forwarded to a different destination. If yes, then it is determined whether or not the user datagram protocol port number falls within said limited range of user datagram protocol port numbers.

After having searched through the mapping table, the user datagram protocol packet is usually to be forwarded to a destination given in the mapping table, if such destination has been found in the mapping table, or to be discarded, if no corresponding destination has been found in the mapping table.

Preferably, the present invention can be used for internet protocol (IP) connection, but is not limited thereto.

The above described objects and other aspects of the present invention will be better understood by the following description of preferred embodiments with reference to the accompanying drawings.

### BRIEF DESCRIPTION OF THE DRAWINGS

FIG. 1 shows a schematic block diagram of a WCDMA radio access network with IPCC and AAL2 signalling.

FIG. 2 shows an example of conventional call setups with unique IPTAs and unique UDP sockets.

FIG. 3 shows a continuation of the procedure of FIG. 2.

FIG. 4 shows an example of call setups from the side of a common IPTA on signalling and user plane level.

FIG. 5 shows an example of call setups with unique IPTAs on signalling level, but with a common UDP socket at one peer according to a preferred embodiment of the present invention.

FIG. 6 shows a continuation of the procedure of FIG. 5.

FIG. 7 shows a block diagram of a UTRAN peer-to-peer system comprising corresponding hardware devices.

FIG. 8 shows a block diagram of a GSM/EDGE peer-to-peer system comprising corresponding hardware devices.

FIG. 9 shows a flow diagram of a receiving loop with UDP port numbers of the node limited to a fixed range according to a preferred embodiment of the present invention.

FIG. 10 shows a flow diagram of a receiving loop with UDP port numbers of the peer limited to a fixed range according to a preferred embodiment of the present invention.

FIG. 11 shows a flow diagram of a receiving loop at a peer which sends a common UDP socket as source according to a preferred embodiment of the present invention.

FIG. 12 shows a flow diagram of a receiving loop at a peer which sends unique UDP sockets as source according to a preferred embodiment of the present invention.

### DESCRIPTION OF THE PREFERRED EMBODIMENTS

In an IP UTRAN, so called IP connections carry user plane traffic. If there is an IP connection control signalling (IPCCS) (cf. ITU-T Rec Q.2631.1), a dynamical setup and release of IP connections take place, in particular between IP UTRAN radio network controllers, between an IP UTRAN radio network controller (RNC) and an AAL2 (ATM Adaptation Layer 2)/IPCC Interworking Function (AAL2/IP IWF) device, between IP UTRAN 3G base stations (node B), between an IP UTRAN RNC and an IP UTRAN 3G base station (node B), and between an AAL2/IPCC IWF and an IP UTRAN 3G base station (node B). In order to establish such IP connections, the IPCCS (Internet Protocol Connection Control Signalling) protocol exchanges an IPTA (Internet Protocol Transport Sink Address) including IP addresses and a UDP (User Datagram Protocol) port number, and additional information such as SAID (Signalling Association Identifier), end addresses and traffic characteristics via signalling messages. An IPCC node implementation according to standard assumes the use of unique IPTA values in the IPCCS protocol at both peers for an IP connection corresponding with unique user plane UDP socket identifiers at both peers (called in the following unique UDP sockets).

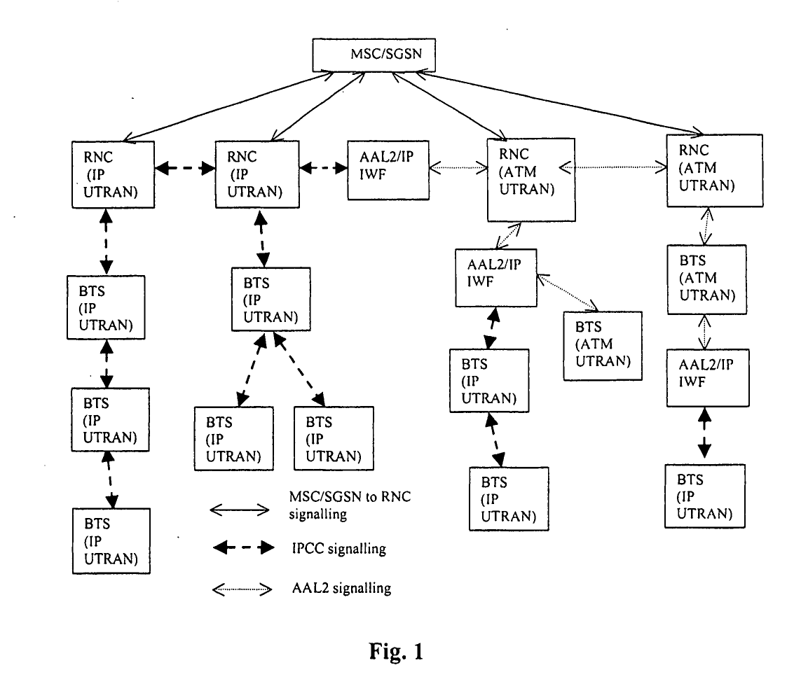

FIG. 1 schematically shows such a network which consist of MSC-SGSN (Mobile Switching Center/Serving Gateway Support Node) core network nodes and a WCDMA (Wideband Code Division Multiple Access) radio ac-cess network (RAN) with IPCC (Internet Protocol Connection Control) and AAL2 signalling functionality. The MSC-SGSN core network nodes are coupled to radio network controllers RNC (IP UTRAN) of an IP UTRAN and to radio network controllers RNC (ATM UTRAN) of an ATM UTRAN. 3G base stations (node B) BTS (IP UTRAN) are coupled to the RNCs (IP UTRAN), and 3G base stations (node B) BTS (ATM UTRAN) are coupled to the RNCs (ATM UTRAN). An AAL2/IP IWF device is interconnected between radio network controllers RNC or base stations BTS of an IP UTRAN and ATM UTRAN, respectively. FIG. 1 shows where IPCC signalling may be applied.

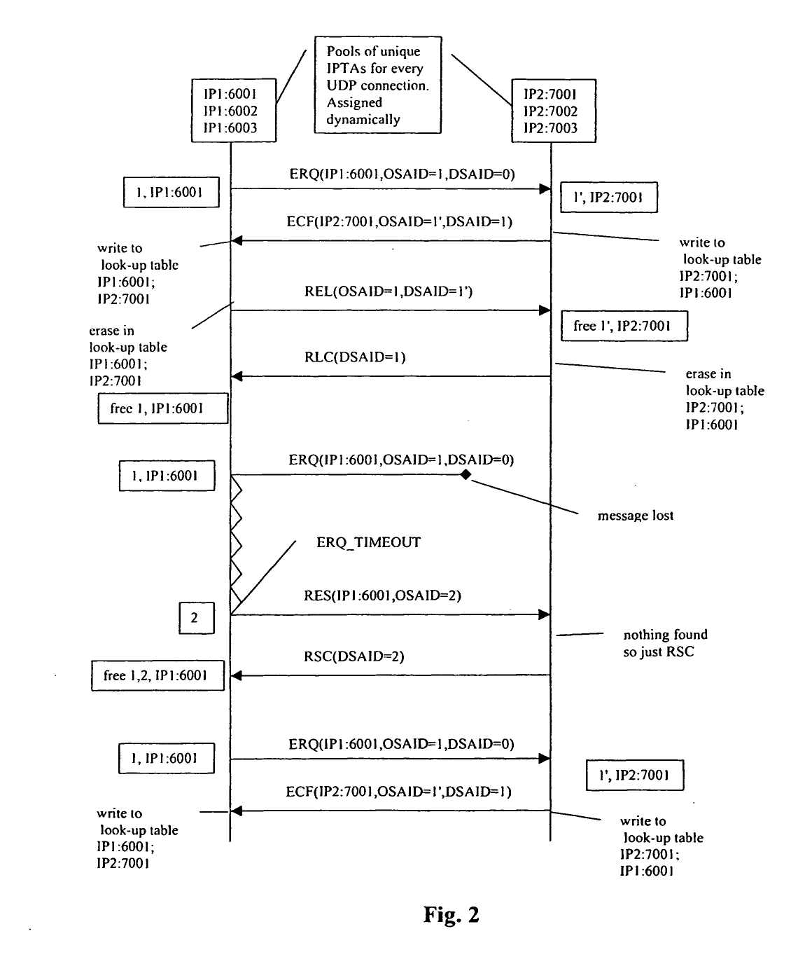

FIG. 2 shows an example of call setups with unique IPTAs (IP Transport Sink Address) and unique UDP sockets, including the handling of “Establish Request” ERQ, and “Establish Confirm” ECF, “Release” REL, “Release Confirm” RLC, “Reset” RES and “Reset Confirm” RSC and the processing of an Originating Signalling Association Identifier OSAID and a Destination Signalling Association Identifier DSAID. In particular, from FIG. 2 it is to be observed that, when unique IPTAs are provided at both IPCCS peers, resets are allowed to be carried out, and therefore lost established requests and releases are allowed to be correctly handled.

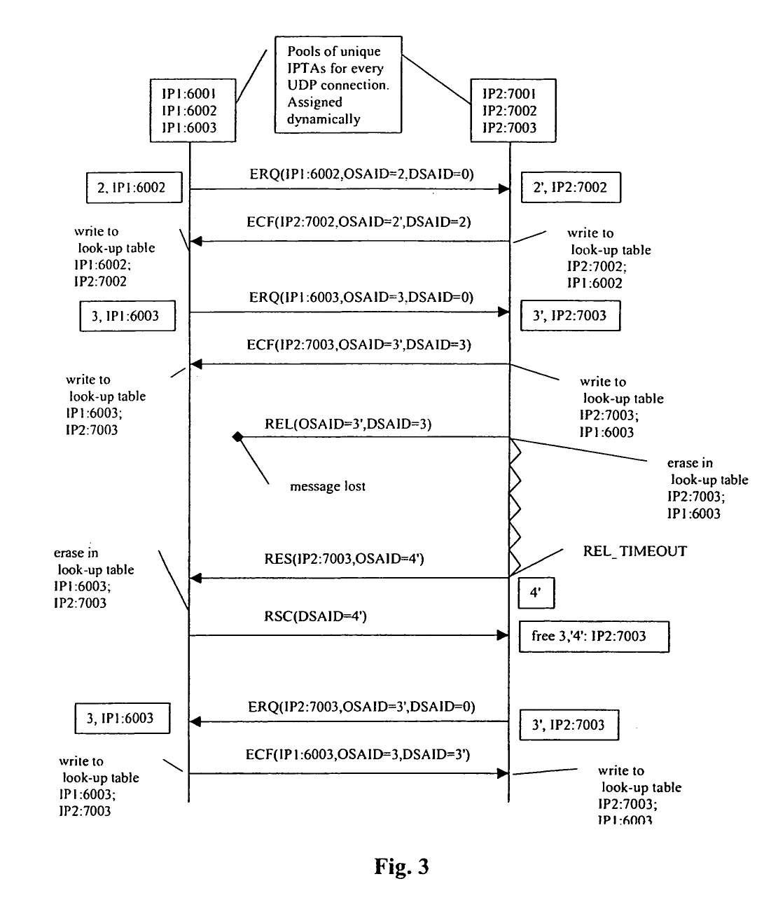

FIG. 3 shows a continuation of the procedure of FIG. 2 and in particular shows that an IPCC reset procedure may be applied by both peers.

As shown in FIGS. 2 and 3, to allow the release of reserved resources in case of suspected inconsistent information on two peer nodes a reset functionality allows to reset single IP connections or all IP connections associated with a particular IP address by sending the local source IPTA to the peer node.

Upon receiving individual user plane packets the receiving node typically checks the IP connection identifiers including the destination IP addresses, the destination UDP port number, the source IP address and the source UDP port number, and decides how to process it. In particular, the receiving node decides whether the packet is for itself or whether it has to forward the packet to another destination node or to discard the packet due to an invalid IP connection.

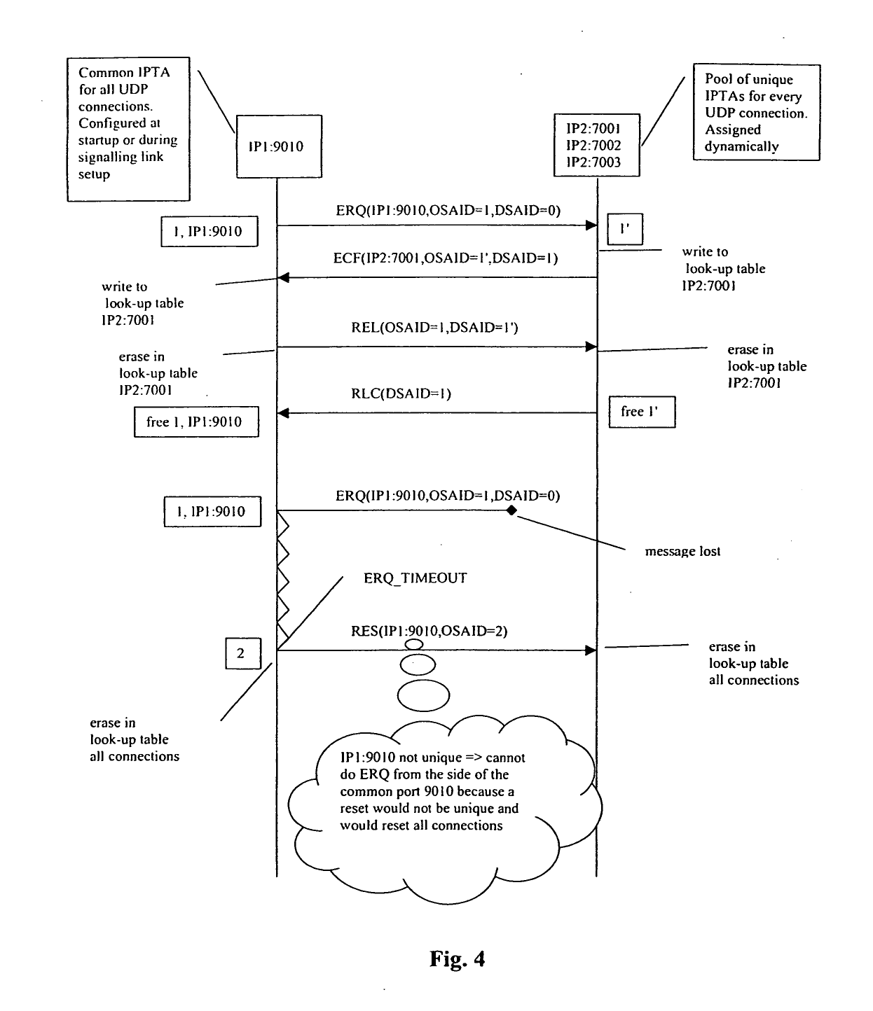

FIG. 4 shows an example of call setups with unique and common IPTAs, wherein a common IPTA is provided at peer 1 (the lefthand peer in FIG. 4). From FIG. 4 it is to be observed that an IPCC signalling with a common IPTA at one peer (lefthand peer 1 according to FIG. 4) on signalling and user plane level results in difficulties when a reset from the side of the common port is needed.

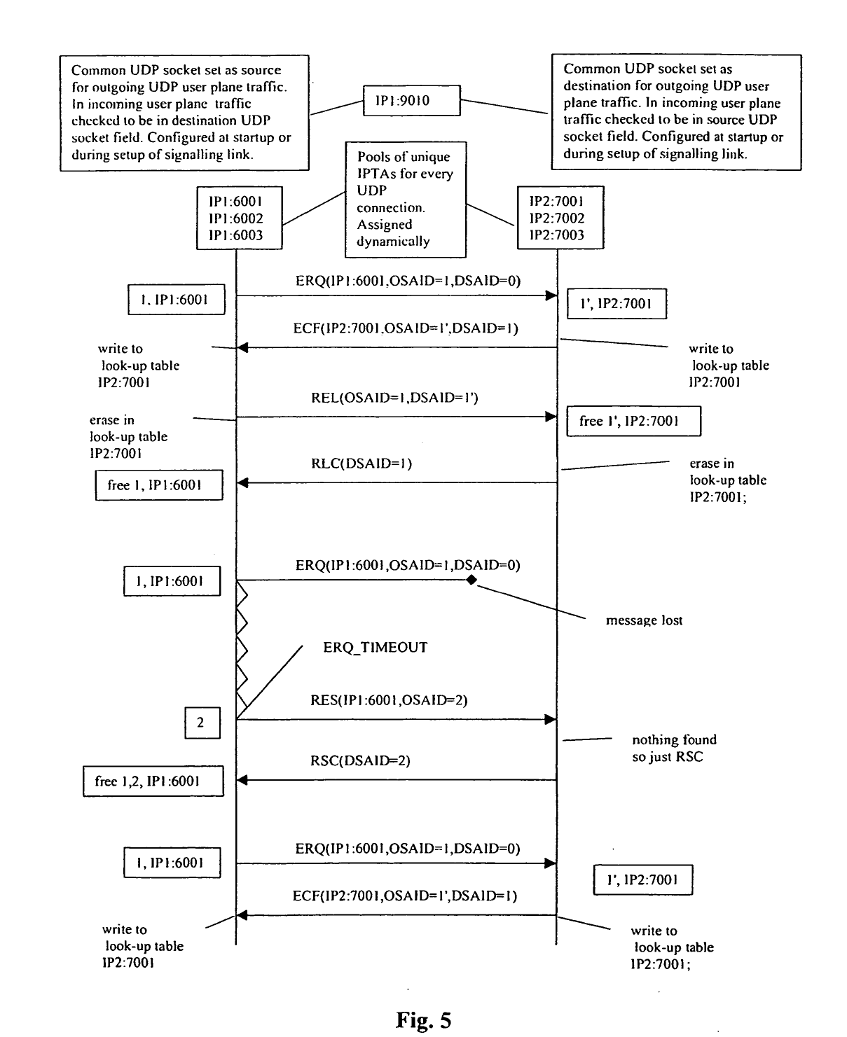

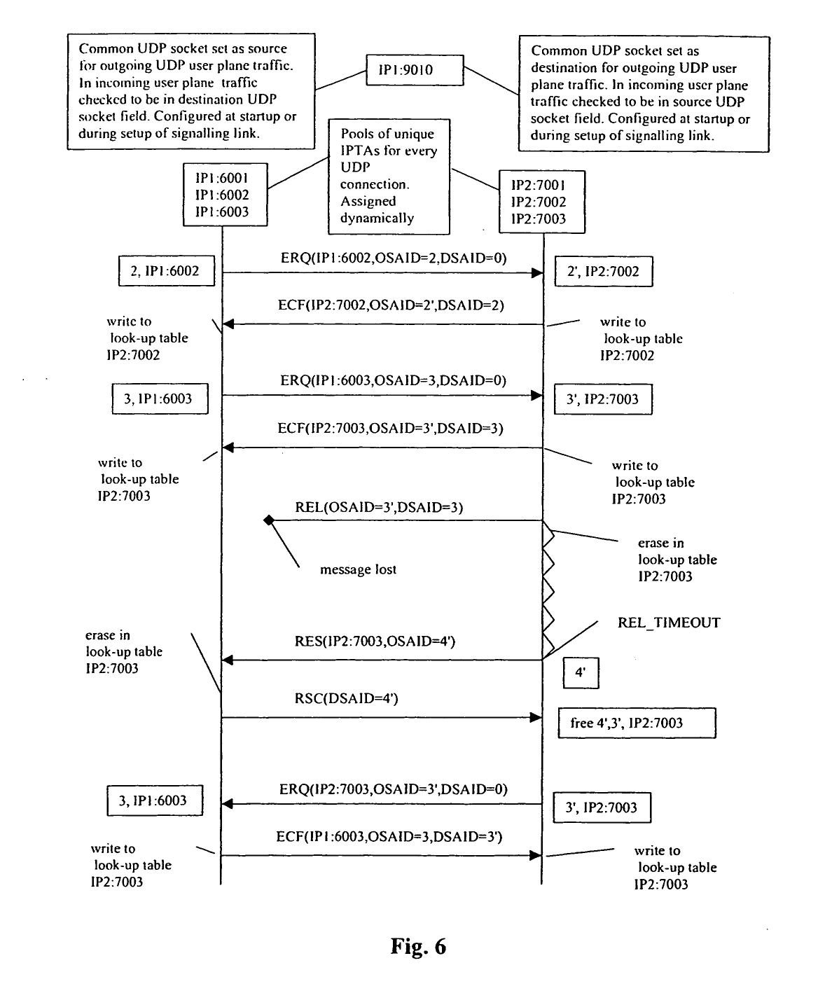

FIG. 5 shows an example of call setups with unique IPTAs on signalling level but with a common UDP socket on peer 1. FIG. 6 is a continuation of the procedure of FIG. 5. From FIGS. 5 and 6 it is to observed that a common UDP socket only on user traffic level but unique IPTAs on signalling level allow to carry out resets and, thus, allow lost established requests and releases from both peer sides to be correctly handled, while having less UDP sockets to be stored and searched in look-up tables.

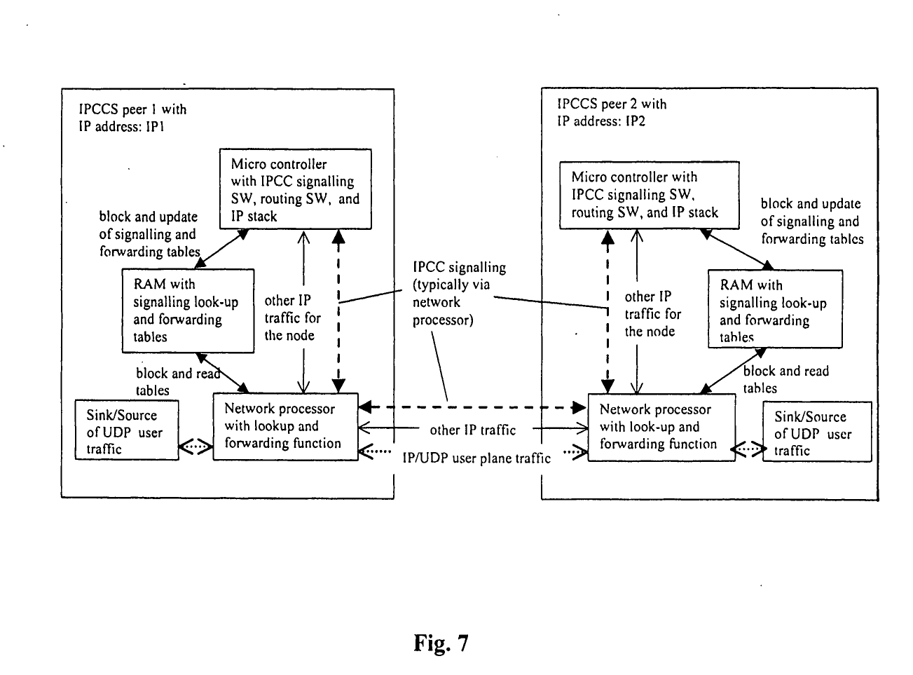

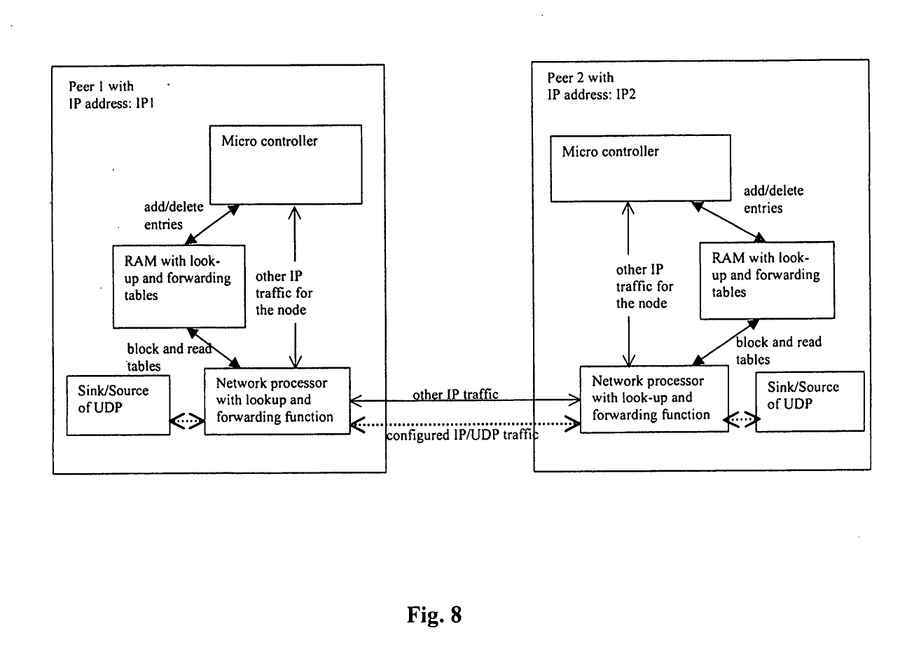

FIG. 7 schematically shows a basic implementation in a UTRAN peer-to-peer system including functions of an IPCC signalling function, an IP-stack processing, typically running on a micro controller, and an IP/UDP packet processing provided by a specialized hardware or a network processor. FIG. 8 schematically shows a corresponding basic implementation in a GSM/EDGE system to which the FIGS. 1 to 6 do not apply as far as they refer to IPCC signalling. In the peer-to-peer systems of FIGS. 7 and 8, the unique UDP socket information exchanged is stored in look-up tables in a RAM. The IP/UDP packet processing hardware or the network processor need to consult the look-up tables in the RAM to decide to which destination the UDP packets be forwarded.

Usage of a limited range of UDP sockets or a common UDP socket allow several possibilities to efficiently implement the user plane traffic processing. First the source and destination UDP sockets are extracted from the received UDP packets. Then the packet processing checks whether the received destination address contains the node's IP address. If it does not, the packet is forwarded to its destination or is discarded. UDP packets containing the node's IP address in its destination can then be classified and treated efficiently with several methods. The following three are only examples:

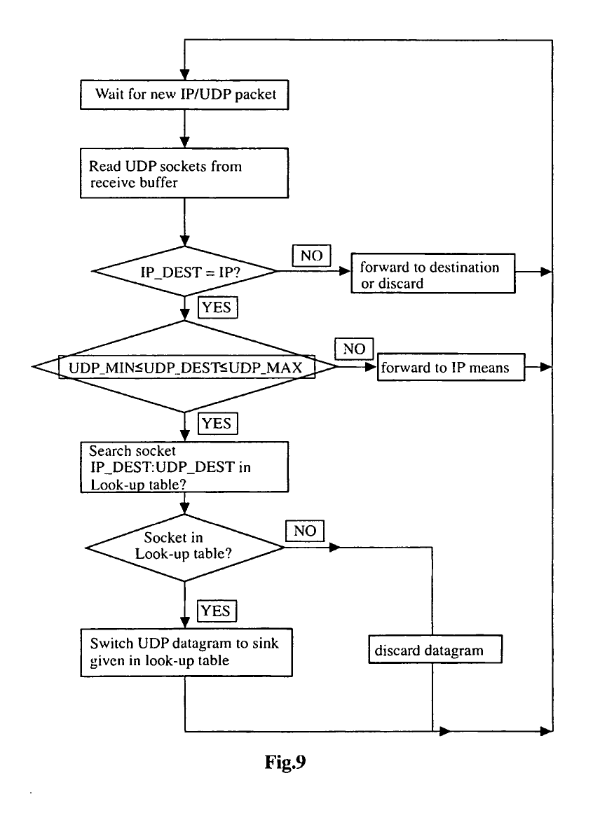

1.) A peer which sends UDP sockets from a limited range as source can look in received UDP traffic for the destination UDP port and compare it to the maximum and minimum allowed UDP port to decide whether to continue searching in the look-up table or to forward the packet to a different IP means like an IP stack or other applications. This processing is shown by the flow chart of FIG. 9.

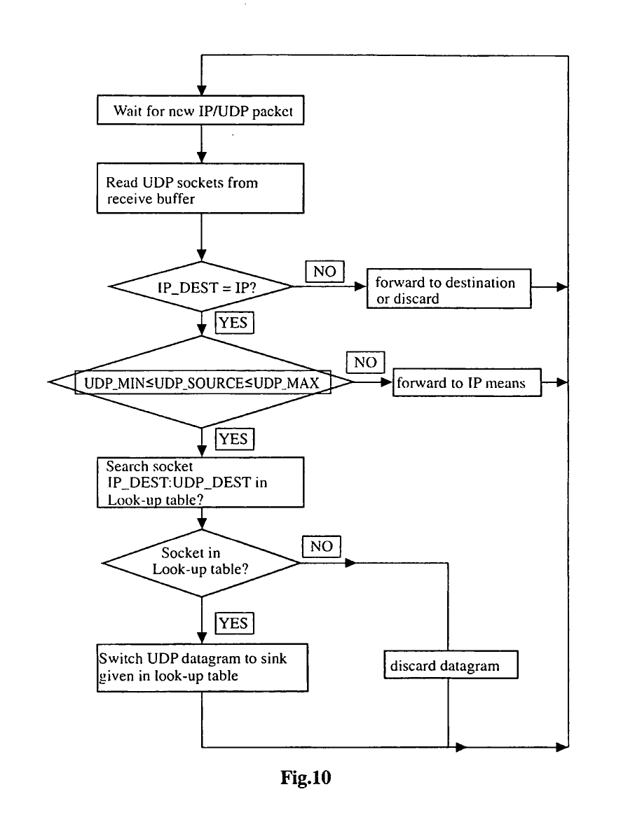

2.) If only the other peer limits its UDP port socket range, the not limiting peer can check the received source UDP port to be inside a range when receiving UDP traffic. This range then has to be known on both peers during set-up of the signalling link. This processing is shown by the flow chart of FIG. 10.

3.) A common UDP socket for peer 1 is configured on both sides of the IPCC connection. On one side the common UDP socket is set as source of outgoing user plane traffic and expected sink of incoming user plane traffic and on the other side as destination of outgoing user plane traffic and optionally as expected source of incoming user plane traffic. This common UDP socket is thus used during header creation of UDP traffic and efficient classifying of incoming UDP traffic in the UDP traffic processing hardware device.

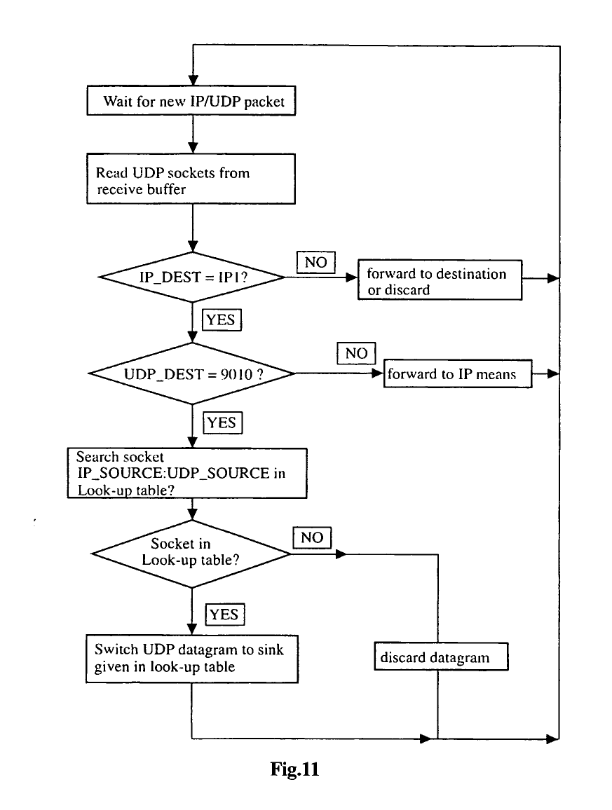

The peer which sends the common UDP socket as source compares the destination UDP port of the received UDP packet with the common UDP port. If the destination UDP port is not equal to the common UDP port it is forwarded to a different IP means like an IP-stack otherwise the received source UDP socket is searched in a look-up table. If a look-up table entry matches, then the UDP packet is switched or forwarded to the sink otherwise it is discarded. This processing is shown by the flow chart of FIG. 11.

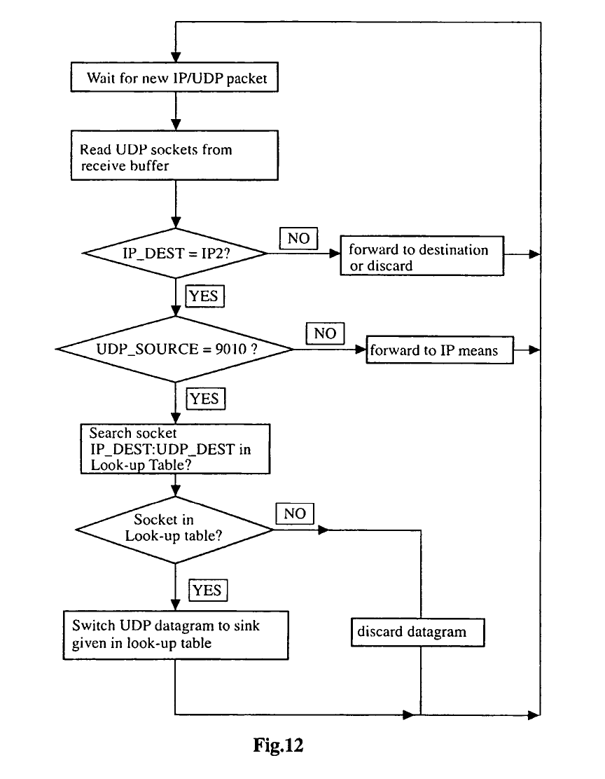

The peer which sends unique UDP sockets as destination compares the source UDP port of the received UDP packet with the common UDP port. If the source UDP port is not equal to the common UDP port it is forwarded to the IP means, otherwise the received destination UDP socket is searched in a look-up table. If a look-up table entry matches, then the UDP packet is switched or forwarded to the sink otherwise it is discarded. This processing is shown by the flow chart of FIG. 12.

Although the invention is described above with reference to preferred examples, it is apparent that the invention is not restricted to it, but can vary in many ways within the scope disclosed in the attached claims.

What is claimed is:

1. A device for user datagram protocol packet processing on network elements in a network, comprising
user datagram protocol ports, wherein a predetermined limited range of user datagram protocol port numbers is only provided;
mapping table means including a mapping table;
means for determining, when a user datagram protocol packet arrives, whether or not a user datagram protocol port number associated with said user datagram protocol packet falls within said limited range of user datagram protocol port numbers; and
means for searching through said mapping table, if said associated user datagram protocol port number is determined as falling within said limited range of user datagram protocol port numbers.

2. The device of claim 1, wherein said associated user datagram protocol port number is a destination user datagram protocol port number.

3. The device of claim 1, wherein said associated user datagram protocol port number is a source user datagram protocol port number.

4. The device of claim 1, further comprising means for discarding said user datagram protocol packet or forwarding it to an internet protocol means for further processing, if said associated user datagram protocol port number is determined as not falling within said limited range of user datagram protocol port numbers.

5. The device of claim 1, further comprising at least two peers coupled to each other, wherein at least one of said peers comprises a limited range of user datagram protocol port numbers, and at least another of said peers comprises a unique user datagram protocol port for each internet protocol connection.

6. The device of claim 1, further comprising at least two peers coupled to each other, wherein at least two of said peers comprise a limited range of user datagram protocol port numbers.

7. The device of claim 1, wherein said limited range of user datagram protocol port numbers is reduced to one common user datagram protocol port.

8. The device of claim 1, comprising user datagram protocol ports for connection control signalling and related user plane traffic.

9. The device of claim 5, wherein the actually used user datagram protocol port numbers for the internet protocol connections are separated from internet protocol transport sink address values transferred in the connection control signalling protocol.

10. The device of claim 9, wherein the internet protocol transport sink address values at least at two of said peers are uniquely associated with each individual internet protocol connection.

11. The device of claim 10, further comprising means for mapping the inter protocol transport sink address values to said limited range of user datagram protocol port numbers at least at one of said peers, and means for one-to-one mapping between the internet protocol transport sink address values and the user datagram protocol ports at least at another of said peers.

12. The device of claim 9, wherein the connection control signalling is an internet protocol connection control signalling.

13. The device of claim 1, comprising predetermined user datagram protocol ports for related traffic.

14. The device of claim 1, further comprising means for determining, when a user datagram protocol packet arrives, whether or not a destination internet protocol address associated with said user datagram protocol packet is the internet protocol address of a receiving device;
means for forwarding said user datagram protocol packet to said means for determining whether or not a user datagram protocol port number associated with said user datagram protocol packet falls within said limited range of user datagram protocol port numbers, if said destination internet protocol address is determined as being the internet protocol address of the receiving device; and
means for discarding said user datagram protocol packet or forwarding it to a different destination means, if said destination internet protocol address is determined as being not the internet protocol address of the receiving device.

15. The device of claim 1, further comprising
means for forwarding said user datagram protocol packet to a destination given in said mapping table, if said searching means has found such a destination in the mapping table, and
means for discarding said user datagram protocol packet, if said searching means has not found any corresponding destination in said mapping table.

16. A radio access network means comprising a device of claim 1.

17. A method for user datagram protocol packet processing on network elements in a network, comprising the steps of
providing a predetermined limited range of user datagram protocol port numbers;
determining, when a user datagram protocol packet arrives, whether or not a user datagram protocol port number associated with said user datagram protocol packet falls within said limited range of user datagram protocol port numbers; and
searching through a mapping table, if said associated user datagram protocol port number is determined as falling within said limited range of user datagram protocol port numbers.

18. The method of claim 17, wherein said associated user datagram protocol port number is a destination user datagram protocol port number.

19. The method of claim 17, wherein said associated user datagram protocol port number is a source user datagram protocol port number.

20. The method of claim 17, further comprising discarding said user datagram protocol packet or forwarding it to an internet protocol means for further processing, if said associated user datagram protocol port number is determined as not falling within said limited range of user datagram protocol port numbers.

21. The method of claim 17, further comprising providing a limited range of user datagram protocol port numbers at least at one peer and a unique user datagram protocol port for each internet protocol connection at least at another peer coupled to the one peer.

22. The method of claim 17, further comprising providing a limited range of user datagram protocol port numbers at least at two peers coupled to each other.

23. The method of claim 17, wherein said limited range of user datagram protocol port numbers is reduced to one common user datagram protocol port.

24. The method of claim 17, wherein user datagram protocol ports are provided for connection control signalling and related traffic.

25. The method of claim 21, wherein the actually used user datagram protocol port numbers for the internet protocol connections are separated from internet protocol transport sink address values transferred in the connection control signalling protocol.

26. The method of claim 25, wherein the internet protocol transport sink address values at least at two of said peers are uniquely associated with each individual internet protocol connection.

27. The method of claim 26, comprising the further steps of
mapping the internet protocol transport sink address values to said limited range of user datagram protocol port numbers at least at one of said peers; and
one-to-one mapping between the internet protocol transport sink address values and the user datagram protocol ports at least at another of said peers.

28. The method of claim 25, wherein the connection control signalling is an internet protocol connection control signalling.

29. The method of claim 17, wherein predetermined user datagram protocol ports are provided for related traffic.

30. The method of claim 17, further comprising
determining, when a user datagram protocol packet arrives, whether or not a destination internet protocol address associated with said user datagram protocol packet is the internet protocol address of a receiving device, and
forwarding said user datagram protocol packet to said means for determining whether or not a user datagram protocol port number associated with said user datagram protocol packet falls within said limited range of user datagram protocol port numbers, if said destination internet protocol address is determined as being the internet protocol address of the receiving device, or
discarding said user datagram protocol packet or forwarding it to a different destination means, if said destination internet protocol address is determined as being not the internet protocol address of the receiving device.

31. The method of claim 17, further comprising
forwarding said user datagram protocol packet to a destination given in said mapping table, if such a destination has been found in the mapping table, or
discarding said user datagram protocol packet, if no corresponding destination has been found in said mapping table.
